(19) United States
(12) Patent Application Publication
(10) Pub. No.: US 2004/0015336 A1
(43) Pub. Date: Jan. 22, 2004

(54) Automatic detection and assessment of chemical, biological, radiological and nuclear threats

(76) Inventors: James J. Kulesz, Oak Ridge, TN (US); Brian A. Worley, Knoxville, TN (US); Richard W. Reid, Knoxville, TN (US); Wayne H. Griest, Oak Ridge, TN (US); Robert H. Morris, Knoxville, TN (US); Ronald W. Lee, Oak Ridge, TN (US); Marcus B. Wise, Kingston, TN (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/199,733

(22) Filed: Jul. 19, 2002

(51) Int. Cl. G06G 7/48

(52) U.S. Cl. 703/11; 436/100

(57) ABSTRACT

A system and method for detection and assessment of hazardous plumes includes at least one sensing station, the sensing station including at least one sensor for sampling a media and determining hazardous plume data. The hazardous plume data includes at least one hazardous plume component and quantitative data regarding the hazardous plume component, such concentration. A computing structure receives the hazardous plume data and determines a dispersion model including a future migration path of the plume. The dispersion model can also provide quantitative data regarding the hazardous plume component, such as the concentration associated with the projected plume as a function of time as well as the source location of the plume.

### STATEMENT REGARDING FEDERALLY SPONSORED RESEARCH OR DEVELOPMENT

The United States Government has rights in this invention pursuant to Contract No. DE-AC05-000R22725 between the United States Department of Energy and UT-Battelle, LLC.

### CROSS-REFERENCE TO RELATED APPLICATIONS

Not applicable.

### FIELD OF THE INVENTION

This invention relates to automatic detection and assessment of chemical, biological, radiological and nuclear threats.

### BACKGROUND OF THE INVENTION

Natural disasters, such as, earthquakes, hurricanes, floods and tornadoes have occurred on occasion throughout history. Currently, society is faced with increasing threats from manmade disasters from chemical, biological, radiological or nuclear sources. The manmade disasters can be triggered by accidents or through intentional actions, such as through terrorist attacks.

These emergency situations can affect all or a portion of the people and the property in a given geographic region. Currently, advanced early warnings for these natural and manmade catastrophic threats are either non-existent or are received by only a very small percentage of the population when disasters threaten.

The few early warning systems in operation today suffer many deficiencies. They generally warn areas much larger than is necessary. They provide warnings only for a limited number of threats and are not universal in nature. They do not provide timely warnings. They also typically rely on warning sirens that must be in hearing range or on broadcast warnings that rely on an active receiver with human attention and human responses.

For the above reasons, only a small percentage of the threatened population from a disaster actually receives an early warning from any source. When received, the warning may not be timely or may be ignored as a probable false alarm for the location of the receiver.

U.S. Pat. No. 6,169,476 to Flanagan discloses an early warning system for natural and manmade disasters which collects and analyzes data as disasters occur, and when necessary, transmits early warnings to cause mitigation responses to lessen the disaster's impact on lives and property. The system uses a plurality of sensing, detection and reporting sources, comprising both human and automated sources, for collecting and transmitting data about disasters. A central processing site receives this data and determines the type, magnitude, speed, direction, and the expected geographic area to be impacted. A plurality of cell relays are disposed across a geographic area covered by the system, the respective cell relays for exclusively retransmitting warning signals received from a warning transmitter for receipt by devices located within the respective cells. The system determines which cell relays will receive the warning signal based on the expected geographic area to be impacted, thus only alerting those in the projected path of a threat.

At least three transmissions are required for communicating the warning signal. First, data from the sensing, detection and reporting sources is transmitted to a central data receiving station for processing and data analysis. Second, an area warning transmitter station then transmits the warning to selected cell relays disposed in respective cells. Finally, the cell relays retransmit the warning signal to receiver devices located within the respective cells.

Thus, although the system disclosed by Flanagan represents an improvement over conventional alert systems, the Flanagan system is complex as it requires at least three transmissions to deliver the warning signal. The system is also not fully automatic. In addition, since the sensing, detection and reporting sources are remotely located relative to the cell relays, sensor measurements cannot be made within the respective cells. Moreover, Flanagan does not disclose or suggest prediction of plume dispersion, or quantification (e.g. concentration) of detected hazardous materials or hazardous components. Accordingly, threat predictions generated by the system are generally highly inaccurate.

In addition, Flanagan does not disclose or suggest a method or apparatus for pinpointing the source location of a disaster, such as a bomb including nuclear fallout, sometimes referred to as a “dirty bomb”. Pinpointing the source location of such a bomb or other release can be a required step for accurate plume dispersal modeling as well as for hazardous material containment purposes. Thus, there is a need for fully automated, reliable and accurate threat identification prediction system to address threats brought on by releases of hazardous chemical, biological, radiological and nuclear materials by terrorists or by accident.

### SUMMARY OF INVENTION

A system for rapid detection and assessment of hazardous plumes includes at least one sensing station, the sensing station including at least one sensor for sampling a media and determining hazardous plume data. The term “plume”, as used herein, refers to a volume in a media, such as air, water, or soil which contains the hazardous component. The hazardous plume data includes at least one hazardous plume component and quantitative data regarding the hazardous plume component. The system can include sensors to detect hazardous components, such as biological, chemical, or nuclear materials as well as electromagnetic radiation. The sampled media can comprise air, water or soil. The system is preferably fully automatic.

The system also includes a computing structure, such as modeling software, for receiving the hazardous plume data and determining a dispersion model including a future migration path of the plume. The projected migration path preferably includes concentration and levels of hazardous components in the plume as a function of both time and position. The dispersion model can also be used to determine a source location for the hazardous component. The source location is a location upon which the hazardous threat was introduced and can be a point, line or a volume. The system preferably also includes structure for directly transmitting the hazardous plume data to the computing structure.

As used herein, the term radiation includes material elements that contain radioactive isotopes, such as the elements Cs and Sr, fundamental particles, such as neutrons and alpha particles, as well as electromagnetic radiation, such as x-rays and gamma rays.

The computing structure can include meteorological data in determining the dispersion model. The sensing station can include at least one meteorological sensor for obtaining meteorological data.

The system can include a network of sensing stations, the network disposed across a plurality of remotely located sites. The system can include at least one wireless communications link for communications between the sensing station and the computing structure. Structure for encrypting the hazardous plume data can be included in the system for encryption of the sensor data prior to transmission thereof.

The sensing station can be a mobile sensing station. In this embodiment, the sensing station preferably includes a global position system.

The sensing station can include at least one mass spectrometer. The mass spectrometer can be a chemical biological mass spectrometer (CBMS) adapted to detect and measure a concentration of hazardous chemical and biological materials. The mass spectrometer can comprise an ion trap mass spectrometer. Biological and chemical sensors other than CBMS based may be used with the invention, provided they meet the system requirements for precision, accuracy, repeatability and minimum detectable concentration levels.

A method for detection and assessment of hazardous plumes includes the steps of sampling a media and determining hazardous plume data. The hazardous plume data includes quantitative data regarding at least one hazardous component. A dispersion model is then computed relating to a migration path of the hazardous plume from the hazardous plume data. The hazardous component can be one or more of biological, radiological, chemical, and nuclear components. The method can be fully automated.

The method can include the steps of updating the hazardous plume data by repeating the determining step, and using the updated hazardous plume data to recompute the dispersion model. The method can also include the step of providing a population database and compiling a threat assessment based on the dispersion model and the population database.

### BRIEF DESCRIPTION OF THE DRAWINGS

A fuller understanding of the present invention and the features and benefits thereof will be accomplished upon review of the following detailed description together with the accompanying drawings, in which:

FIG. 1 is a block diagram illustrating a system for assessing hazardous threats, according to an embodiment of the present invention.

FIG. 2 is a flow chart illustrating a method for assessing hazardous threats, according to an embodiment of the present invention.

FIGS. 3(a) and (b) shows exemplary predicted plume dispersal data for anthrax as a function of location at two different times.

### DETAILED DESCRIPTION OF THE PREFERRED EMBODIMENTS

A system for rapid detection and assessment of hazardous plumes includes at least one sensing station, the sensing station including at least one sensor for sampling a media and determining hazardous plume data. The plume data comprises at least one hazardous plume component and quantitative data regarding the hazardous plume component, such as concentration or level of the component. The system preferably also includes modeling software for receiving the plume data and determining a dispersion model including a predicted migration path of the plume. In the event of a hazardous material release, information about plume characteristics can then be sent to one or more emergency response centers in the case of homeland security, or a command center in a battlefield environment.

The dispersion model can also provide levels of hazardous components associated with the projected migration path. In addition, the dispersion model can determine the source location of the plume. Once determined, source location can be used to improve plume dispersion modeling and can aid in forensics, such as for interdiction of terrorists, cleanup or containment following a hazardous release.

The sensors provided by the system are preferably capable of detecting both the presence and level of a plurality of chemical and biological components, as well as radiological and nuclear components. Sensors can be provided as a suite of modules. The architecture for the sensor modules provided, such as chemical, biological, nuclear and radiological sensors, are generally defined for parameters including sensor size, volume, power draw, accuracy, precision, repeatability, sensitivity, and compatibility with the overall system architecture.

Biological components can include a variety of bacteria, toxins and viruses, while chemical components can include chemical toxins, such as sarin. Sarin is a poisonous liquid, C₄H₁₀FO₂P, that inhibits the activity of cholinesterase and is used as a nerve gas in chemical warfare.

In a preferred embodiment, the system is adapted to measure radiological levels and various nuclear components, in addition to chemical and biological agents. Regarding nuclear components, measured radiological levels permit nuclear concentrations to be inferred.

Current and evolving instruments for battlefield chem-bio detection are exclusively designed to provide qualitative presence or absence measurements. In contrast, sensors have been modified for use in the system to provide quantitative measurements, such as absolute levels of chemical and biological materials. Quantitative sensor measurements permit improved prediction of the migration path of a plume and a better estimate of the impact of a given hazardous material release as compared to prior art qualitative measurement systems, such as the system disclosed by Flanagan. A quantitative sensor system also permits accurate determination of the source location of a hazardous release.

One such sensor permitting quantitative measurements is a modified chemical-biological mass spectrometer (CBMS). The CBMS is modified to add an internal standard to the environmental sample as it is taken. Modified software identifies the chemical or biological agent and uses the measured response of the internal standard to calculate its concentration or level in the sample. Such a modified CBMS can provide quantitative measurements, such as absolute levels of chemical and biological materials. A CBMS does not utilize consumables. Other sensors (besides a modified CBMS), preferably also being consumable-free, may be used to measure chemical and biological threats, provided they are capable of meeting requirements for precision, accuracy, repeatability, sensitivity, and compatibility with the system architecture. For example, ion mobility spectrometry may be used for identification of chemical agents and immunoassay or polymerase chain reaction assays for biological threats. However, very few of the chemical agent sensors and the biological agent assay methods available provide quantitative measurement capability.

CBMS can detect known and unknown chemical agents in less than 45 seconds and a large group of biological agents in less than 5 minutes. Direct sampling ion trap mass spectrometry (DSITMS) is the underlying technology for CBMS. No other available device has this capability. The CBMS or other devices for detecting chemical and biological components preferably include automated analysis. As used herein, “automated analysis” refers to automatic operation without the necessity of a human operator, including startup with mass and frequency (or other, as appropriate for the specific sensor) calibration, automated detection, identification and quantification of agents and levels thereof, transmission of alarm messages, and continuous self-monitoring for instrumental faults.

Radiological detection can be provided by inclusion of a variety of devices. For example, three common types of radiological sensors include a proportional counter, a Geiger-Müller counter, and a Reuter-Stokes ionization chamber. A radiological sensor can detect the presence of a “dirty bomb”, and through dosimetry, reconstruct the dose delivered.

Nuclear sensors are generally passive sensors which measure the energy spectrum of the nuclear source. Nuclear detection can be provided by inclusion of a collection of passive materials, such as foils, films and ceramics that respond predictively to exposure to specific energy levels from a nuclear event.

Sensor calibration can also proceed automatically. The CBMS and other DSITMS instruments perform calibrations appropriate to the specific sensor, such as mass and frequency calibrations, automatically and without human intervention. In the case of chemical and biological releases, precise calibration samples, such as surrogates having a known composition and quantitative level, can be injected into the instrument periodically through action of appropriate automated devices to assure the instrument maintains the prescribed level of accuracy.

Measured chemical, biological and other sensor data from the sensing station can be forwarded to the modeling software for analysis. In a preferred embodiment of the invention, radiological levels, nuclear particle concentrations, as well as meteorological data is provided to the modeling software for determining plume dispersion and related data. Sensor data is preferably forwarded to one or more computing structures using remote telemetry. For example, satellite communications, standard wireless communications or a local area network (LAN) can be used for this purpose.

Alternatively, computing structures can be provided at one or more of the respective sensing stations. In one embodiment, each sensing station includes a computing structure for determining plume dispersion and related data.

To provide system security, the measured sensor data can be encrypted. This can eliminate false alarms from being generated in response to non-legitimate sensor data.

Meteorological data can include temperature, relative humidity, atmospheric pressure, wind direction and speed, solar radiation and rainfall. Meteorological data can be provided from a weather service, or from meteorological instruments disposed at the sensing stations.

Plume related data can include calculated plume characteristics, including source estimates and plume migration estimates over time. The plume migration over time can include concentration or level estimates for the hazardous components detected.

The modeling software can be a customized program which includes a plume dispersion model or a modified version of the software architecture used for the U.S. military hazard prediction and assessment capability (HPAC). HPAC is a government-owned software system that is publicly available with approval from the holding agency. Other plume dispersion models, both commercial and government-owned models are available as well. Although plume models other than HPAC can be used with the invention, HPAC is generally preferred as it is fast, modular in nature and includes modules such as population estimates, terrain and exposure effects.

The underlying software capability is for modeling material dispersions and ground depositions over time. Using HPAC, the predictive computational results are available within a few minutes or less. HPAC is a platform-independent, client-server, web-based architecture and includes nuclear effect models, population databases and models, and a water transport model. Water can include groundwater or a public water supply. HPAC is owned by the U.S. government and has been provided free of charge to civilian emergency organizations.

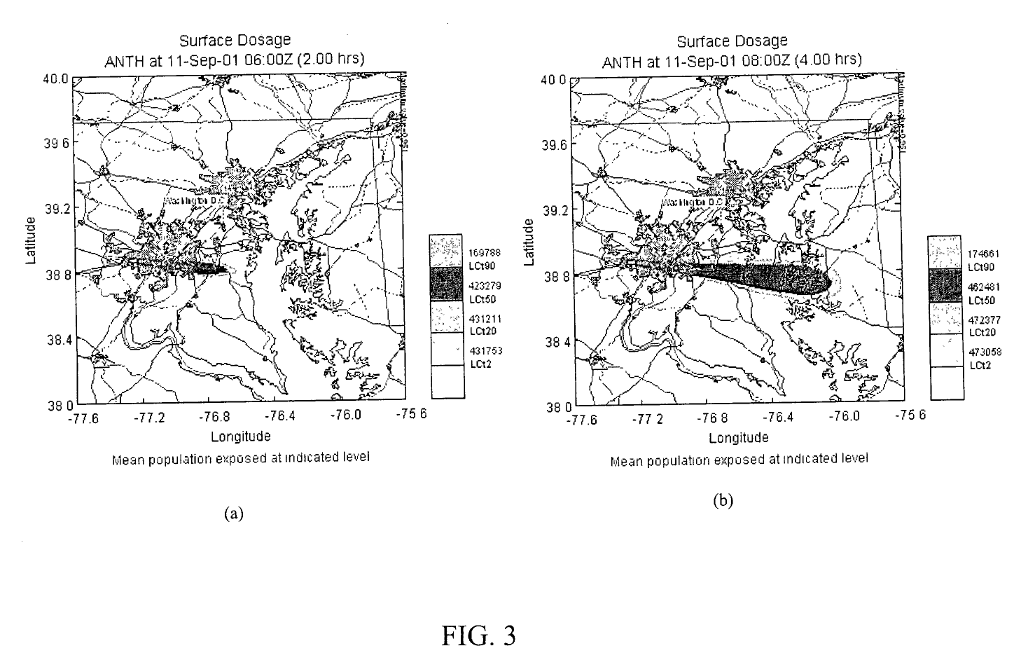

Together with available population databases, a population effects model can be compiled including the estimated number of affected people (e.g. dead or ill) from data generated by the dispersion model (See FIG. 3(a) and (b)). HPAC is currently used in all U.S. military command centers throughout the world.

The system can provide the plume modeling data to a number of remotely located sites. For example, this information can be transmitted over-the-air to theater commanders or one or more regional and/or national emergency response centers. Data can also be archived for latent exposure evaluations using suitable memory at the sensing stations or structure for computing.

The media sampled can be gaseous (e.g. air), liquid (e.g. water) or a solid (e.g. soil) media. For example, dispersion of hazardous components in water, including chemical, biological, radiological and nuclear releases in waterways can be predicted using predictive water plume models, such as HYTRAS. HYTRAS is a surface water transport model that predicts the transport and settlement of hazardous materials in water. The data generated is the concentration of hazardous material in the water as a function of space and time.

Preferably, the computing structure includes interactive entry of observed hazardous component (e.g. identity and concentration) values before and during the calculation. In one embodiment of the invention, the modeling software (e.g. HPAC) can send instructions (e.g. wireless) to the sensors (e.g. CBMS) for additional sampling locations or additional measurements at the sampled locations to improve the fidelity of plume model.

Sensing stations can be located adjacent to substantially populated regions. However, sensing in unpopulated areas can be important for prediction of plume dispersal toward populated areas. For example, the system can include hundreds, thousands or tens or hundreds of thousands of remotely located sensor stations, such as across an entire region or country. The system is also capable of monitoring worldwide, such as a system using a plurality of sensing stations distributed worldwide in conjunction with one or more satellites for transmitting sensor data to the computing structure for generation of the dispersion model.

The combined systems comprising sensing stations and dispersion models can be deployed using fixed locations sensing stations, as well as mobile sensors, such as on boats, automobiles and planes. Such vehicles can be unmanned, such as drones. Fixed locations can include towers, such as those used for cellular telephony. Existing cellular towers can be retrofitted to include the inventive system while continuing to operate in their originally intended fashion.

For mobile sensing platforms, geo-positioning systems (GPS) sensors could also be used. In this case, the geospatial coordinates for the sensor locations are generally necessary to associate the data obtained with a spatial location.

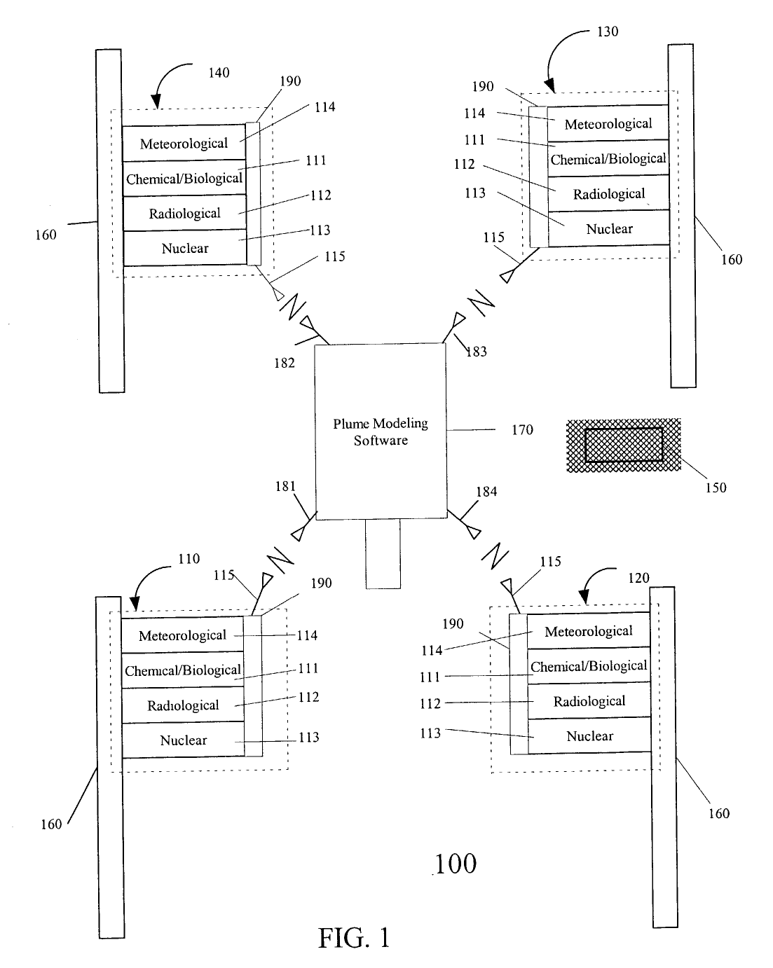

FIG. 1 is a block diagram illustrating a system 100 for assessing airborne hazardous threats, according to an embodiment of the present invention. System 100 includes four (4) spaced apart sensing stations 110, 120, 130 and 140. Each sensing station (110, 120, 130 and 140) includes chemical/biological 111, radiological 112, nuclear 113 and meteorological 114 sensors. Chemical/biological 111, radiological 112, nuclear 113 sensors are capable of determining both the identity of the hazardous component(s) as well as their concentration. For example, chemical/biological sensor 111 can be a CBMS. Although shown as being combined, chemical/biological sensor 111 can be separate sensors.

Sensing stations preferably include at least one transceiver 190 and an antenna 115 for transmitting and receiving wireless signals. Sensing stations are shown disposed on towers 160, such as those used for cellular telephony.

A computing structure 170 is shown for receiving the hazardous plume data from sensing stations (110, 120, 130 and 140) and determining a dispersion model including a future migration path of the plume. Computing structure includes at least one transceiver (not shown) and antennas 181, 182, 183 and 184. Thus, computing structure can not only receive data from sensing stations 110, 120, 130 and 140, but can also communicate with any of these sensing stations, such as to direct a specific sampling from one or more selected sensing stations. The dispersion model preferably is a quantitative model and includes a determination of the source location of the plume.

A hazardous source 150 is shown in FIG. 1. Hazardous source 150 can be a “dirty bomb”. Dirty bomb 150 is shown disposed closer to sensing stations 120 and 130 as compared to sensing stations 140 and 150. Accordingly, the radiological levels measured at sensing stations 120 and 130 from dirty bomb 150 will generally be substantially higher as compared to the radiological levels measured at sensing stations 110 and 140.

Quantitative radiological and weather data from sensing stations 110, 120, 130 and 140 can be used for pinpointing the source location of the dirty bomb 150. Pinpointing the source location of dirty bomb 150 can be important data for accurate plume dispersal modeling as well as for containment purposes.

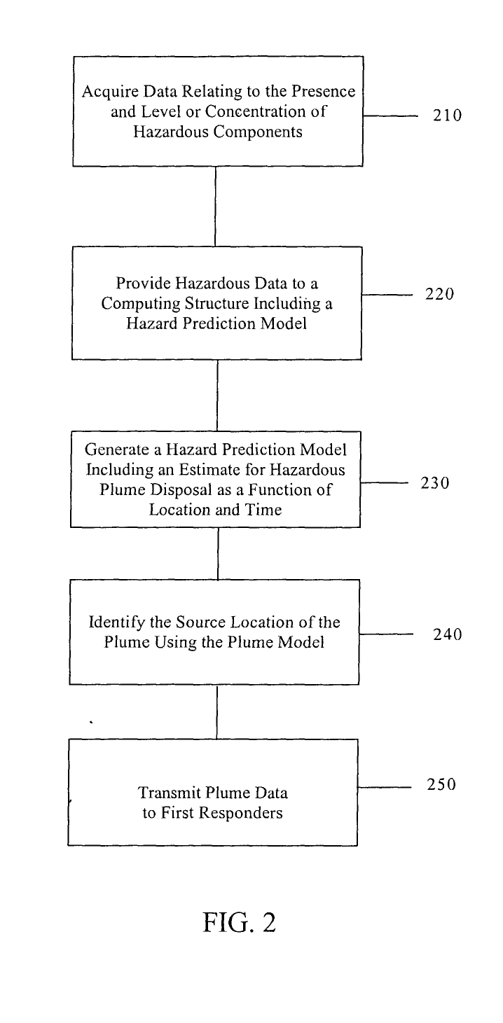

FIG. 2 is a flow chart illustrating a method for assessing hazardous threats, according to an embodiment of the present invention. In step 210, data is acquired relating to the presence and level or concentration of one or more hazardous components, such as from sensing station 110 shown in FIG. 1. The hazardous component data is then provided to a computing structure including a hazard prediction model in step 220. The computing structure then generates a hazard prediction model including an estimate for plume dispersal as a function of both time and location in step 230. The computing structure also preferably determines the source location of the plume in step 240. Plume data is then transmitted to one or more first responders or a command center in step 250 for mitigation and/or warning measures. For example, the information about plume characteristics can be sent to one or more emergency response centers in the case of homeland security, or a command center in a battlefield environment.

FIGS. 3(a) and 3(b) show exemplary predicted plume dispersal data for anthrax at 2 hours and 4 hours after a simulated release, respectively. This data can be used to warn only those who will actually be threatened by a dispersing plume to be evacuated.

### EXAMPLE

An integrated hazard detection and assessment system underwent field testing at cellular communication towers in Tennessee on Mar. 11 and 12, 2002. The field test included a Block II CBMS for detection of airborne chemical agents in the mail room of the City-Center building in Knoxville, Tenn., a direct sampling ion trap mass spectrometer for detection of chemical agents in air and compounds in water in Chattanooga, Tenn., and a Block II CBMS for detection of airborne chemical and biological agents in Nashville, Tenn.

All sensors were networked over an existing conventional phone line system to a Central Command Center at the State of Tennessee Office of Homeland Security in Nashville, Tenn. Detection information and local meteorological data were input to HPAC for plume prediction. The results of the field test performed are summarized in the table below:

| | Detection and | Total elapsed |
|---|---|---|
| Agent | Identification time (S) | Time of test (S)^{a} |
| Air Tests | | |
| Sarin simulant | 4-25 | 39-96 |
| (methyl salicylate) | | |
| Anthrax simulant | 29-40 | 64-77 |
| [Bacillus globigi (BG)] | | |
| Water Tests | | |
| Chloroform | 1.7-2.0 | ^{b} |

^{a}Total elapsed time from injection in the sensor to detection, identification, and hazard plume prediction at the command center.
^{b}HPAC water plume dispersion modeling was not performed for chloroform in water.

As shown above, the time for detection and identification of the simulated airborne chemical threat (methyl salicylate), simulated airborne biological threat (Bacillus globigi) and waterborne chemical threat (chloroform) was less than or equal to 40 seconds. The three sensing stations all transmitted the detection and identification information obtained to the Central Command Center for plume analysis.

The total elapsed time for the detection, identification and hazardous plume prediction for the airborne chemical and biological simulated threats at the Central Command Center was less than or equal to 96 seconds.

During a separate test, the telephone connections were placed in standby mode (no open lines) and a Sarin gas simulant was sprayed into the sensors at the three locations contemporaneously. The system was then required to automatically call the Command Center and convey the sensor data. The Central Command Center successfully received sensor data without the loss of information from simultaneous alerts at the three remotely located sensor locations. Although three sensor stations were used in the test performed, the invention may be practiced with hundreds or thousands of remotely locate sensor stations, such as across an entire country.

Although the sensor locations did not include meteorological instruments for determining localized weather conditions, the system used could have readily accommodated the same. Localized weather information at the respective sensor locations can enable improved plume modeling. In addition, although not included in the test performed, radiological and nuclear sensors could also have been included to detect a radiological or nuclear release.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

What is claimed is:

1. A system for detection and assessment of hazardous plumes, comprising:
at least one sensing station, said sensing station including at least one sensor for sampling a media and determining hazardous plume data, said hazardous plume data comprising at least one hazardous plume component and quantitative data regarding said hazardous plume component, and
computing structure for receiving said hazardous plume data and determining a dispersion model including a future migration path of said plume.

2. The system of claim 1, further comprising structure for directly transmitting said hazardous plume data to said computing structure.

3. The system of claim 1, wherein said dispersion model includes a concentration or level of said component along said future migration path.

4. The system of claim 1, wherein said hazardous component is at least one selected from the group consisting of biological materials, chemical materials, nuclear materials and electromagnetic radiation.

5. The system of claim 1, wherein said dispersion model determines a source location for said hazardous component.

6. The system of claim 1, wherein said computing structure includes meteorological data in determining said dispersion model.

7. The system of claim 6, said sensing station includes at least one meteorological sensor.

8. The system of claim 1, wherein said system comprises a network of sensing stations, said network disposed across a plurality of remotely located sites.

9. The system of claim 1, further comprising at least one wireless communications link for communications between said sensing station and said computing structure.

10. The system of claim 1, wherein said sampled media comprises air.

11. The system of claim 1, wherein said sampled media comprises water.

12. The system of claim 1, wherein said sensing station is a mobile sensing station, said sensing station including a global position system.

13. The system of claim 1, wherein said sensing station comprises at least one mass spectrometer.

14. The system of claim 13, wherein said mass spectrometer is a chemical biological mass spectrometer (CBMS) adapted to detect and measure a concentration of hazardous chemical and biological materials.

15. The system of claim 14, wherein said mass spectrometer comprises an ion trap mass spectrometer.

16. The system of claim 1, wherein said system is fully automatic.

17. The system of claim 1, further comprising structure for encrypting said hazardous plume data.

18. A method for detection and assessment of hazardous plumes, comprising the steps of:
sampling a media,
determining hazardous plume data, said hazardous plume data including quantitative data regarding at least one hazardous component, and
computing a dispersion model relating to a migration path of said hazardous plume from said hazardous plume data.

19. The method for claim 18, wherein said hazardous component comprises at least one selected from the group consisting of biological, radiological, chemical, and nuclear components.

20. The method of claim 18, wherein said method is fully automatic.

21. The method of claim 18, further comprising the step of directly transmitting said hazardous plume data for including in said dispersion model.

22. The method of claim 18, further comprising the step of providing meteorological data for inclusion in said dispersion model.

23. The method of claim 18, wherein said hazardous plume data is acquired at a plurality of remotely located sites.

24. The method of claim 23, wherein said determining step includes obtaining quantitative data regarding said hazardous component at said plurality of remotely located sites.

25. The method of claim 18, further comprising the step of determining a source location of said hazardous component.

26. The method of claim 18, further comprising the steps of updating said hazardous plume data by repeating said determining step, and using said updated hazardous plume data to recompute said dispersion model.

27. The method of claim 18, further comprising the steps of providing a population database and compiling a threat assessment based on said dispersion model and said population database.

28. The method of claim 18, further comprising the steps of encrypting said hazardous plume data and transmitting said encrypted hazardous plume data prior to said computing said dispersion model.
